(19) United States
(12) Patent Application Publication
(10) Pub. No.: US 2014/0271445 A1
(43) Pub. Date: Sep. 18, 2014

(54) METHOD OF PROCESSING WASTE CHLOROSILANE

(71) Applicant: Heritage Research Group, Indianapolis, IN (US)

(72) Inventors: Perry Eyster, Brownsburg, IN (US); Sibel Selcuk, Westfield, IN (US)

(21) Appl. No.: 14/204,713

(22) Filed: Mar. 11, 2014

Related U.S. Application Data
(60) Provisional application No. 61/781,330, filed on Mar. 14, 2013.

(51) Int. Cl. C01C 1/16

(52) U.S. Cl. CPC C01C 1/164
USPC 423/471

(57) ABSTRACT

A method of processing waste chlorosilanes which comprises: obtaining a source of waste chlorosilanes; combining the waste chlorosilanes with a solution of ammonium hydroxide to form a reaction product of ammonium chloride and a siloxane gel; and separating the ammonium chloride from the siloxane gel.

### RELATED APPLICATION

The present application is based on U.S. Provisional Application Ser. No. 61/781,330, filed Mar. 14, 2013 to which priority is claimed under 35 U.S.C. §120.

### BACKGROUND

The present invention relates generally to a method for treating a plurality of streams containing chlorosilicon compounds. More specifically the present invention relates to a process for treating a plurality of streams containing chlorosilicon compounds, including waste chlorosilanes, to obtain a solid siloxane gel that is suitable for disposal and an ammonium chloride product.

A wide variety of commercial silicone polymers are produced by the hydrolysis of a few basic chlorosilanes. In addition, pure silicon metal that is useful in the fabrication of semiconductor devices is made from the reduction of certain chlorosilanes. These important chlorosilane monomers are produced by processes that also yield minor amounts of by-products. For example, methylchlorosilanes are obtained from the reaction of methyl chloride with silicon by what is commonly called the “direct process” method, and chlorosilanes are produced from the reaction of silicon metal with hydrogen chloride. Because of the commercial importance of these and other processes for producing chlorosilanes, large amounts of by-product streams are generated, including waste chlorosilane.

The eventual disposition of these by-product and waste streams has become a significant problem as the production volume of silicone polymers has increased. Both the increased volume of the waste streams and the complexity and variability of the individual streams contribute to the waste disposal problems of a commercial silicone operation.

One method of treating waste chlorosilane involves blending a slurry of calcium hydroxide with the waste chlorosilane to generate highly cross-linked siloxane gels and calcium chloride. These two waste streams are then disposed of separately. The solid or gel is often landfilled and the salt solution is sent through a water treatment system for eventual wastewater disposal.

The present invention provides a method for treating a plurality of streams containing chlorosilicon compounds, including waste chlorosilane which allows for the generation of a single smaller waste stream and a valuable product.

### BRIEF SUMMARY

According to various features, characteristics and embodiments of the present invention which will become apparent as the description thereof proceeds, the present invention provides method of processing waste chlorosilanes which comprises the steps of:

a) obtaining a source of waste chlorosilanes;

b) combining the waste chlorosilanes with a solution of ammonium hydroxide to form a reaction product of ammonium chloride and a siloxane gel; and

c) separating the ammonium chloride from the siloxane gel.

### BRIEF DESCRIPTION OF THE DRAWING

The present invention will be described with reference to the attached drawing which is given as non-limiting example only, in which:

FIG. 1 is a diagram of a method of processing waste chlorosilane according to one embodiment of the present invention.

### DETAILED DESCRIPTION OF THE DRAWINGS AND THE PRESENTLY PREFERRED EMBODIMENTS

The present invention provides a method for treating a plurality of streams containing chlorosilicon compounds, including waste chlorosilanes, to obtain a solid siloxane gel that is suitable for disposal and an ammonium chloride product.

The method of the present invention involves the hydrolysis of waste chlorosilane using ammonium hydroxide as a chloride scavenger or acceptor.

The ammonium hydroxide is provided in a aqueous solution that is blended with waste chlorosilane. The reaction produces ammonium chloride which can remain in solution or, preferentially, it can be precipitated out as a wet solid. The ammonium chloride both in solution and solid form has value as a fertilizer and in a variety of non-agricultural applications such as in metalworking. The gels produced by the reaction form the only waste stream from the inventive method and can be disposed in much the same manner as in the traditional process discussed above that blends a slurry of calcium hydroxide with the waste chlorosilane.

Because the ammonium hydroxide and ammonium chloride remain soluble a recycling process can be used which allows for the rinsing of the gels with make-up water that can be returned to the hydrolysis process. Additionally, this reuse allows for the concentrating of the valuable ammonium chloride salt until it can be precipitated by implementing a cooling step.

The reaction between the waste chlorosilane and ammonium hydroxide is exothermic and therefore generates heat that increases the solubility of the ammonium chloride.

The general method involves blending waste chlorosilane with ammonium hydroxide solution. The resulting hydrolysis reaction generates heat of reaction that allows an increase in the solubility of ammonium chloride that is produced.

The siloxane gel from the reaction is physically removed by filtration, centrifuging or by any other suitable process and the filtrate which contains the ammonium chloride is cooled to precipitate out excess ammonium chloride.

The siloxane gel which is recovered from is rinsed by clean water, thereby producing a rinse water stream that contains residual ammonium chloride that was removed from the filtered gel.

The filtrate and rinse water stream can be combined together and used to make addition ammonium hydroxide solution for subsequent reaction with waste chlorosilane. Prior to recycling the filtrate and rinse water stream these two streams can be cooled to precipitate excess ammonium chloride. The cooling can be performed separately to each of the filtrate and rinse water stream of these two streams can be combined and subjected to cooling together to remove excess ammonium chloride.

FIG. 1 is a diagram of a method of processing waste chlorosilane according to one embodiment of the present invention.

As indicated in FIG. 1 a source of waste chlorosilane is combined with an ammonium hydroxide solution in a reactor 1. The resulting hydrolysis reaction produces a siloxane gel and ammonium chloride. The siloxane gel is removed by filtration at step 2 in FIG. 1 and the filtered gel is rinsed with clean water at step 3. Rinsed gel from which the ammonium chloride has been removed is recovered in step 3.

The filtrate from step 2 and rinse water recovered from step 3 are combined and cooled in step 4 to cause precipitation of excess ammonium chloride which is recovered as a useful product. The liquid from step 4 is recycled as a makeup stream for the ammonium hydroxide solution that is used in a subsequent reaction.

The overall method or process used by the present can be performed on a batch or continuous basis using suitable and conventional processing equipment.

The method of the present invention can be provided with filtration steps that remove unwanted material such as dissolved metals, finely divided catalyst, etc. that are present in the waste chlorosilane. In particular the concentration of any dissolved metals can be controlled within pre-prescribed criteria for use as a micronutrient and/or mineral.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A method of processing waste chlorosilanes which comprises the steps of:
a) obtaining a source of waste chlorosilanes;
b) combining the waste chlorosilanes with a solution of ammonium hydroxide to form a reaction product of ammonium chloride and a siloxane gel; and
c) separating the ammonium chloride from the siloxane gel.

2. A method of processing waste chlorosilanes according to claim 1, wherein at least a portion of the ammonium chloride is separated from the siloxane gel by subjecting the reaction product of step b) to a physical separation process that recovers an aqueous ammonium chloride solution.

3. A method of processing waste chlorosilanes according to claim 2, wherein the physical separation process comprises a filtration process.

4. A method of processing waste chlorosilanes according to claim 2, wherein the separated siloxane gel is further rinsed with water to remove residual ammonium chloride in the rinsing water.

5. A method of processing waste chlorosilanes according to claim 2, wherein the ammonium chloride is precipitated out from the aqueous ammonium chloride solution.

6. A method of processing waste chlorosilanes according to claim 4, wherein the ammonium chloride is precipitated out from the aqueous ammonium chloride solution and from the rinsing water.

7. A method of processing waste chlorosilanes according to claim 6, wherein the aqueous ammonium chloride solution and rinsing water are combined together prior art precipitating out the ammonium chloride therefrom.

8. A method of processing waste chlorosilanes according to claim 5, wherein the liquid recovered after precipitating out the ammonium chloride is used to prepare the ammonium hydroxide used in step b).

9. A method of processing waste chlorosilanes according to claim 6, wherein the liquid recovered after precipitating out the ammonium chloride is used to prepare the ammonium hydroxide used in step b).

10. A method of processing waste chlorosilanes according to claim 7, wherein the liquid recovered after precipitating out the ammonium chloride is used to prepare the ammonium hydroxide used in step b).

11. A method of processing waste chlorosilanes according to claim 1, which further comprises separating at least a portion of any dissolved metals or catalyst from the ammonium chloride.
